(19) United States
(12) Patent Application Publication
(10) Pub. No.: US 2020/0149662 A1
(43) Pub. Date: May 14, 2020

(54) HIGH TEMPERATURE CLAMPS AND METHODS OF MAKING THE SAME

(71) Applicant: MEGGITT SAFETY SYSTEMS, INC., Simi Valley, CA (US)

(72) Inventors: RANDALL LEWIS, Simi Valley, CA (US); Grigor Kerdanyan, Van Nuys, CA (US)

(21) Appl. No.: 16/746,957

(22) Filed: Jan. 19, 2020

Related U.S. Application Data
(63) Continuation-in-part of application No. 15/462,777, filed on Mar. 17, 2017, now Pat. No. 10,550,870.

(51) Int. Cl. F16L 3/12; F16B 2/06

(52) U.S. Cl. CPC F16L 3/1211; F16B 2/065

(57) ABSTRACT

A clamp comprising a top and a base each having a body and at least one arm that is cantilevered away from the body. The top has a through hole that passes through the body. The base is a separate part from the top and comprises a stud that extends from the base to a distal end. A fastener is coupled to the stud such that the fastener can selectively translate along the longitudinal axis of the stud. A first mating interface is cantilevered away from the top or the base. The top is coupled to the base by placing the through hole down over the stud and permanently capturing the fastener between the first end and the distal end of the stud and aligning the at least one upper arm of the top with the at least one lower arm of the base to capture a bushing.

### CROSS-REFERENCE TO RELATED APPLICATION

This application is a continuation-in-part of U.S. patent application Ser. No. 15/462,777, filed on Mar. 17, 2017, and claims the benefit thereof.

### FIELD

The present patent document relates generally to clamps and bushing inserts for use with clamps and methods of making the same. More specifically, the present patent document relates to a high temperature clamp and bushing inserts for holding sensors, cables and other objects and methods for making the same. In preferred embodiments, the bushing inserts are designed to secure sensors, cables or other objects in a clamp in a high temperature situation.

### BACKGROUND

In many applications, sensors, thermistors, wires, cables, cabling or other objects need to be secured by clamps. In situations where temperatures are extremely high, standard clamps and bushings cannot be used. For example, above 600° F. Teflon clamps or bushings cannot be used. To this end, in applications where bushings are needed to be used in conjunction with clamps, both must be made of metal or other heat resistant materials.

FIG. 1 illustrates a dual clamp with two bushings of a previous design rigidly affixed to the clamp. As may be seen in FIG. 1, the two metal bushings 20, each sit on one side of the clamp 10. Each bushing 20 is comprised of two pieces 22 and 24. Top portion 22 is doubled over on itself and has a pair of tabs 22 that each wrap around the edge of the top portion of the clamp 10. Bottom portion 24 of the bushing 20 is also doubled over on itself but has a long tongue portion 24A that extends up secure around the rod of hinge 28 of clamp 10. To this end, bushing 20 is rigidly affixed to clamp 10. Moreover, the bushing 20 is custom designed for claim 10 and is not necessarily compatible with other types of clamps. In addition, the clamp 10 must be disassembled at hinge 28 in order to attach the bushing 20 to the clamp 10. This causes potential damage to the clamp 10.

FIG. 2 illustrates a p-type clamp with a bushing of a previous design, similar to the design of the bushings in FIG. 1, rigidly affixed to the clamp. The current bushing designs for these high temperature applications are inadequate, expensive, and have a long lead time. In particular, the requirement of reworking the clamps to rigidly attach the bushings is cumbersome and creates inconsistency. A better bushing design for high temperature applications is needed.

### SUMMARY OF THE EMBODIMENTS

Objects of the present patent document are to provide an improved bushing and/or clamp design. In particular, objects of the present patent document include providing an improved bushing and/or clamp design for high temperature applications. The bushings are designed to be used in clamps of various designs and secure sensors, thermistors, cables, wires, tubes or other objects securely in the clamp. Preferably, the new design eliminates or at least ameliorates some of the problems with the existing bushing and/or clamp designs as explained above.

To this end, a new bushing design is provided. In one embodiment, the bushing comprises a body formed from a single piece of metal the body having an “M” shaped cross-section with a first outer leg, second outer leg, first inner leg and second inner leg, wherein the first outer leg and second outer leg are both concave arcs about a central axis and form an outer circumference of the body and wherein the first inner leg and second inner leg each have an arc formed in the leg to create a rounded channel that extends a longitudinal length of the body along the central axis; and wherein the first inner leg and second inner leg transition between each other in a third concave arc. The rounded channel formed by arcs of the inner legs is used to secure the sensors, cables, thermistors, wires, tubes or other objects within the clamp.

In yet another embodiment, a bushing is provided that is formed from a single piece of metal with an “S” shaped cross-section wherein the “S” shaped cross-section has an additional element added to the tail of the “S”. The center portion of the “S” shaped cross-section and the additional element added to the tail run parallel to each other across an interior of the bushing and have opposing arcs that form the central passage for holding sensors, tubes, wires, cables or other elements.

In yet another embodiment, another bushing is provided that is formed from a single piece of metal with an arc that sweeps through 320 degrees or more where the arc defines the outer cylindrical shape of the bushing. A rounded interior passage is formed by opposing arcs in the interior of the bushing where each end of the outer arc turns inward and across the interior of the bushing.

In addition, a new clamp design is provided herein. In a preferred embodiment, the clamp comprises a top with a body and at least one upper arm that is cantilevered away from the body. The body has a through hole in it. The clamp further comprises a base separate from the top wherein the base has a bottom body and at least one lower arm cantilevered away from the bottom body. The base has a stud affixed to the bottom body of the base at a first end and extending therefrom to a distal end. The distal end of the stud is designed to permanently capture a fastener. The fastener is coupled to the stud such that the fastener can selectively translate along the longitudinal axis of the stud. A first mating interface extends away from the top or the base, wherein the top is coupled to the base by placing the through hole down over the stud and permanently capturing the fastener between the first end and the distal end of the stud. The top and base are oriented such that the at least one upper arm and at least one lower arm are aligned.

In preferred embodiments of the clamp, the stud is threaded and the distal end is deformed to capture the fastener. The fastener is preferably a nut.

Although the upper arms and lower arms can be in any shape, they are typically mirror images of each other and are designed to mate in a clam shell fashion to hold an object such as a bushing. In preferred embodiments, the at least one upper arm is a first arc and the at least one lower arm is a second arc. The two arcs oriented one over the other to form a majority of a circle designed to clamp against the outside diameter of a bushing.

In preferred embodiments, the first arc has a first end coupled to the body and the first arc is swept through between 150 and 180 degrees. In even more preferred embodiments, the second arc has a first end coupled to the base and is also swept through between 150 and 180 degrees.

The embodiments of a clamp may further include at least one mating interface. In preferred embodiments, the mating interface is cantilevered away from the top or the base.

In some embodiments, when the top of the clamp is assembled to the base and the fastener is fully tightened, a gap remains between a first distal end of the at least one upper arm and the at least one lower arm. This allows the upper arm and lower arm to act like springs around the bushing they are clamping.

Depending on the clamp embodiment, the clamp may have any number of upper and lower arms to secure any number of bushings. In preferred embodiments, the clamp has two upper arms on opposite sides of the top and two lower arms on opposite sides of the base.

In preferred embodiments. the two upper arms are arcs and the two lower arms are arcs and the axes of rotation of the two upper arms are in the same first plane and wherein the axes of rotation of the two lower arms are in the same second plane. In yet even more preferred embodiments, the first plane and the second plane are the same plane.

Although the clamps may be formed from any number of known manufacturing methods, in preferred embodiments, the top and base of the clamp are made from formed sheet metal.

### BRIEF DESCRIPTION OF THE DRAWINGS

FIG. 1 illustrates a dual clamp with two bushings of a previous design rigidly affixed to the clamp;

FIG. 2 illustrates a p-type clamp with a bushing of a previous design, similar to the design of the bushings in FIG. 1, rigidly affixed to the clamp;

FIG. 3 illustrates one embodiment of a bushing design accordingly to the teachings of the present patent document;

FIG. 4 illustrates a bushing design similar to FIG. 3 but with a small modification to the third concave arc;

FIG. 5 illustrates a cross-sectional view of one embodiment of a bushing similar to the bushing of FIG. 3;

FIG. 6 illustrates another embodiment of a bushing made from a single piece of metal;

FIG. 7 illustrates another embodiment of a bushing;

FIG. 8 illustrates a dual clamp with an embodiment of a bushing similar to the one from FIG. 3 assembled into both slots of the clamp;

FIG. 9 illustrates an embodiment of a bushing similar to the embodiment of FIG. 7, but built with a two-piece construction;

FIG. 10 illustrates an isometric view of a high temperature clamp designed to hold two bushings;

FIG. 11 illustrates the clamp of FIG. 10 with the top in a loosened position and rotated approximately 90 degrees from its clamped position;

FIG. 12 illustrates the clamp of FIGS. 10 and 11 without the bushings present;

FIG. 13 illustrates an isometric view of a clamp similar to those of the previous figures but designed to hold a single bushing;

FIG. 14 illustrates an isometric view of a clamp similar to the clamp in FIG. 13 but designed with only a single mating interface on a side of the clamp adjacent to the upper arm and lower arm.

FIG. 15 illustrates an isometric view of a clamp similar to the clamp in FIG. 14 but designed with only a single mating interface on a side of the clamp opposite to the upper arm and lower arm.

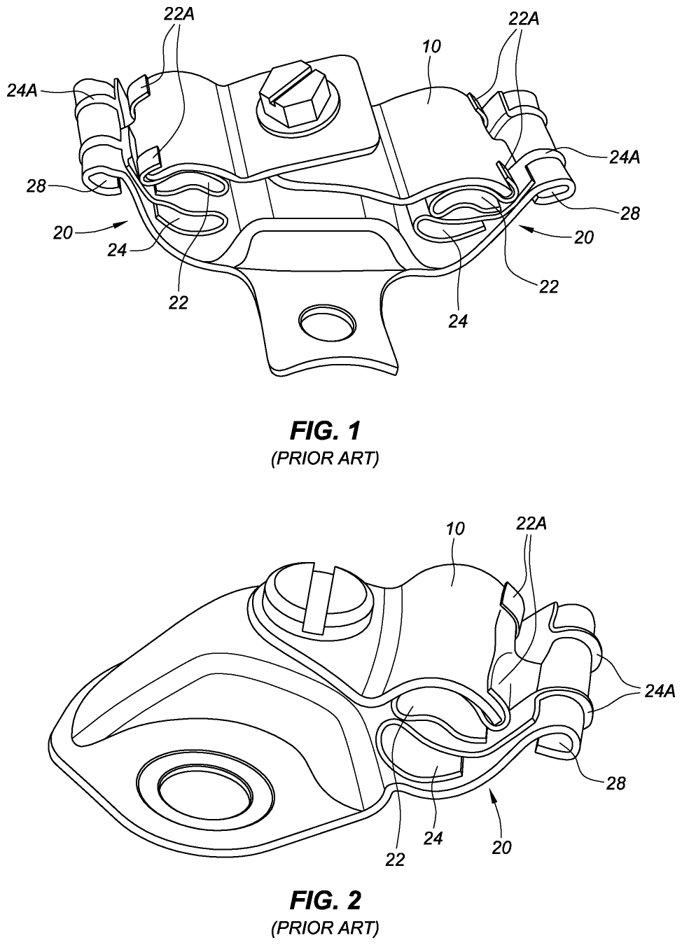

### DETAILED DESCRIPTION OF THE PREFERRED EMBODIMENTS

The present patent document discloses embodiments of a bushing for use in securing wires, cables, sensors, thermistors, tubes or other objects within clamps. The bushings and clamps are particularly designed for high temperature applications. An example of a high temperature application is temperatures above 600° F. Under such conditions, typical Teflon bushings and/or clamps will melt and thus, more robust bushings and clamps are needed. The embodiments of bushings and clamps disclosed herein are designed for use in these high temperature applications.

In preferred embodiments, the high temperature bushing/insert is a formed part and may be formed from a thin sheet metal. However, in other embodiments, the bushing may be extruded. The bushings can be used in any type of existing clamps, such as p-clamps or dual sensor clamps. The high temperature bushing is designed to snap on to and stay attached to the tubing prior to the installation of the clamp. In preferred embodiments, the bushing is also designed to prevent lateral movement in the clamp and has a strain/stress relief feature to prevent chafing of the supported element.

The bushing can be made from any corrosion and heat resistant material. In preferred embodiments, the bushing is made from a metal, for example, stainless steel, Inconel, aluminum or other type of metal.

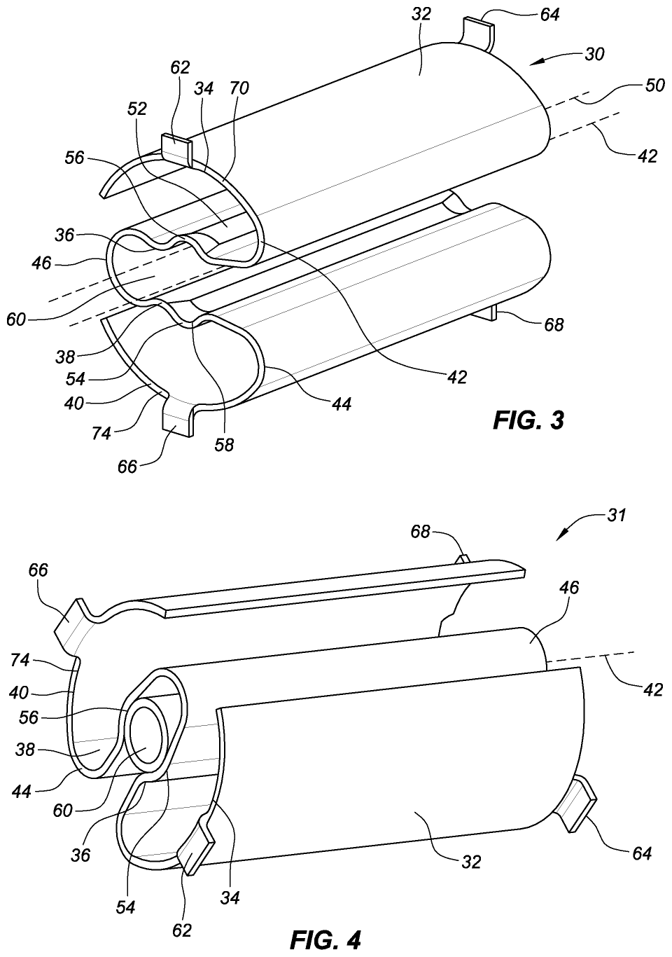

FIG. 3 illustrates one embodiment of a bushing 30 accordingly to the teachings of the present patent document. The bushing 30 has a generally rounded body 32. The overall shape of the body 32 of bushing 30 is cylindrically shaped although the cylinder formed by the body does not have a continuous outer wall.

As may be seen in FIG. 3, in some embodiments, the body 32 of bushing 30 has an “M” shaped cross-section with a first outer leg 34, second outer leg 40, first inner leg 36 and second inner leg 38. In preferred embodiments, the first outer leg 34 and second outer leg 40 are both concave arcs about a central axis 42 and define an outer circumference of the rounded body 32.

Although the cross-section of the embodiment shown in FIG. 3 is generally “M” shaped, it has rounded corners. For example, where the first outer leg 34 transitions to the first inner leg 36 a rounded corner 42 or arc is formed. Similarly, where the second outer leg 40 transitions into the second inner leg 38 a second corner 44 or arc is formed. In preferred embodiments, the first rounded corner 42 and second rounded corner 44 have the same or similar radius of curvatures and sweep through the same arc. In preferred embodiments, the first rounded corner 42 and second rounded corner 44 are identical mirror images of each other. In addition to the first rounded corner 42 and second rounded corner 44, bushing 30 also has a third concave arc 46 where the first inner leg 36 transitions to the second inner leg 38.

In some embodiments, the third concave arc 46 is an arc through 180 degrees or more around a longitudinal axis 50. This creates a rounded curve. In other embodiments, the third concave arc 46 may pass between 150 and 180 degrees.

In the embodiments with an “M” shaped cross-section the first inner leg and second inner leg each have an arc 52 and 54 formed in the leg to create a rounded channel 60 that extends a longitudinal length of the rounded body 32 along the central axis 42. The rounded channel 60 is designed to mate with the cable, wire, sensor, thermistor or other object held by the bushing. In preferred embodiments, the size and shape of the central channel 60 is designed to create an interference fit with the cable, wire, sensor or other object. The interference fit between the bushing and the cable, wire, thermistor, sensor or other object will allow the bushing to clip-on to the object while the clamp is being installed.

Depending on the material used, the central channel may also apply a spring force on the object being held. For example, if the diameter of the object placed in the bushing 30 is slightly larger than the diameter of the rounded channel 60, the two halves of the bushing 30 may be slightly pulled apart by bending the bushing 32 at the third concave arc 46 and placing the item in the rounded channel 60. Assuming the appropriate material is used for the bushing 32, the third concave arc 46 will apply a spring force against the object placed in the rounded channel 60.

In some embodiments, the radius of the rounded channel 60 and the radius of the third concave arc 46 are about the same. This allows the first inner leg 36 and second inner leg 38 to be approximately parallel to each other or only slightly converging or diverging. In many embodiments, the first inner leg 36 and second inner leg 38 are within 10 degrees of parallel and even more preferably within 5 degrees of parallel.

In preferred embodiments, the bushings include tabs 62, 64, 66 and 68 on opposite ends of the body 32 of the bushing 30. These tabs may be on both the top and bottom of the bushing 30 or in some embodiments, only a single set of tabs, for example 62 and 64 on either the top or bottom of the bushing 30. Although the embodiments shown have four tabs, any number of tabs may be used. In some embodiments, 8 tabs, four on each end, may be used. In yet other embodiments, six, ten, twelve, fourteen or sixteen tabs may be used.

The tabs prevent the bushing from moving laterally within the clamp when they are assembled together. The tabs are designed to stick out and away from the body of the bushing on either side of the clamp the bushing is assembled to such that the bushing cannot slide along the longitudinal axis in either direction.

To this end, a preferred embodiment of a bushing 30 includes a first tab 62 and a second tab 64 on opposite ends of the first outside leg 34 and extending outwards from a first outside edge 70 of the first outside leg 34 and a third tab 66 and a fourth tab 68 on opposite ends of the second outside leg 40 and extending outwards from a second outside edge 74 of the second outside leg 40.

In preferred embodiments, the rounded channel 60 has a flared lip 56 and 58 (the flared lip on the opposite end of the body 32 of bushing 30 is not shown in FIG. 3) on both ends of the body. The flared lip is created at the edge of each arc 52 and 54 at both ends of the rounded channel 60. The flared lips 56 and 58 provide strain relief to whatever the bushing is assembled to.

In the embodiment shown in FIG. 3, the bushing 30 is symmetric about a central plane through the central axis 42 and the longitudinal axis 50.

In preferred embodiments, the bushing is a one-piece design. However, other embodiments may use a two-piece design. In yet other embodiments, even more pieces may be used. As used herein, a one-piece design means the entire body of the bushing is made from a single piece. That tabs 62, 64, 66 and 68 are not required to be made from the same piece of metal to satisfy the one-piece design criteria as used herein. In preferred embodiments, tabs 62, 64, 66 and 68 are in fact made from the same piece as the body and are just bent into place. However, in other embodiments, which would still be considered a one-piece design, the tabs are welded onto the body.

FIG. 4. illustrates a bushing design similar to FIG. 3 but with a small modification to the third concave arc 46. As may be seen in FIG. 4, the third concave arc 46 does not sweep through as big an angle as the embodiment in FIG. 3. The third concave arc 46 in FIG. 4 sweeps through less than 180 degrees and thus, the first inside leg 36 and second inside leg 38 are diverging as they extend laterally across the body 32 from the third concave arc 46.

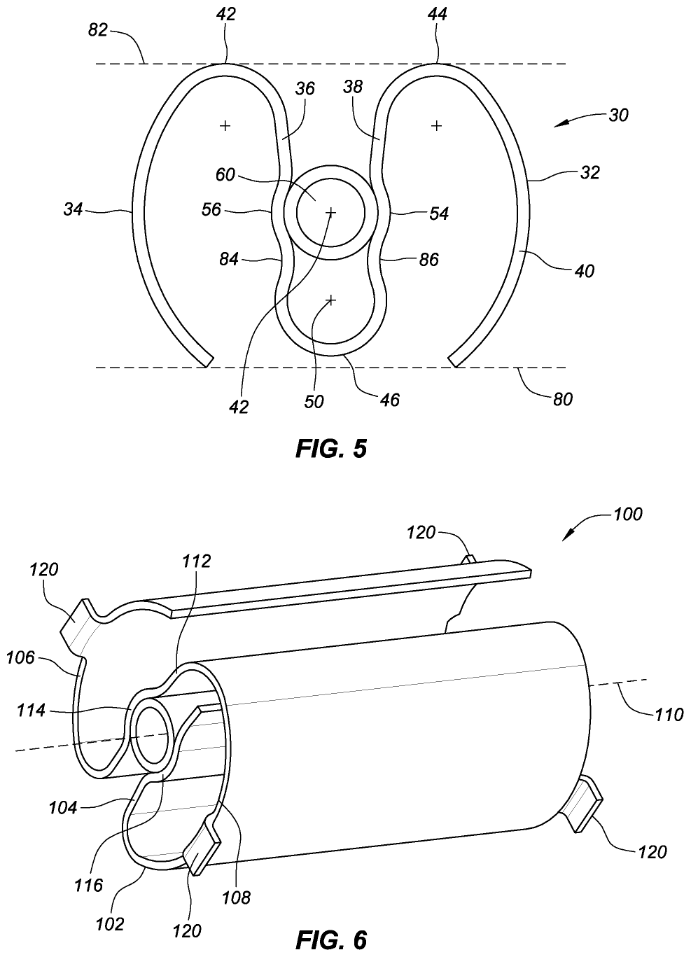

FIG. 5 illustrates a cross-sectional view of one embodiment of a bushing similar to the bushing illustrated in FIG. 3. In order to increase the understanding of the embodiments disclosed herein, the cross-section shown in FIG. 5 will be described using alternative language from what was used to describe FIG. 3. As may be appreciated from FIG. 3, each of the features described runs the full length of the bushing and the cross-section is consistent down the entire length of the bushing 30.

As may be seen in FIG. 5, the bushing 30 has a first concave portion 46 with a first radius on a first side 80 of the bushing 30. The concave portion 46 is an arc that can sweep through a variety of angles as explained previously. In the embodiment shown in FIG. 5, the concave portion 46 sweeps through an angle of 180 degrees or greater. The concave portion 46 curves around a longitudinal axis 50 that runs the length of the bushing 30.

In preferred embodiments, both a top side 84 and a bottom side 86 extend out laterally from the first concave portion 46 to an opposite side 82 of the bushing 30 from the first side 80. Once the top side 82 and bottom side 84 reach the opposite side 82, they each curve back on themselves to form a first convex portion 42 and second convex portion 44 on the second side of the bushing. The first convex portion 42 and second convex portion 44 are above and below the first concave portion 46 respectively. The radius of convex portions 42 and 44 may be any radius and the convex portion may sweep through any arc. However, in preferred embodiments, the convex portions sweep through an arc between 90 and 150 degrees and more preferably between 120 and 150 degrees. Regardless, the convex portions sweep through an arc of at least 90 degrees or more. The radius of convex portions 42 and 44 may be any radius but in a preferred embodiment the radius is about the same as the radius of the concave portion 46. In preferred embodiments, convex portions 42 and 44 are identical mirror images of each other.

After reaching the opposite side 82 and curving through the convex portions 42 and 44, both the top side and bottom side extend laterally back to the first side 84 of the bushing 30 in a first arc 34 and second arc 40 on a top 84 and bottom 86 of the bushing 30 respectively. As may be seen in FIG. 5, the first arc 34 and second arc 40 form the outer circumference of the bushing 30 around a central axis 84.

In the embodiment shown in FIG. 5, as the top 84 portion and bottom 86 portion of the bushing extends from the first concave portion 46 laterally across the bushing 30 to the second side 82, a third concave arc 56 and forth concave arc 54 extend longitudinally across the bushing 30 and are formed around the central axis 42 in the top side 84 and bottom side 86 respectively. The third concave arc 56 and fourth concave arc 54 form the rounded channel 60, which is used to hold the sensor, cable etc. In FIG. 5, a round object is shown held in the rounded channel 60 but, of course, is not part of the bushing 30.

In preferred embodiments, the third and fourth concave arcs 56 and 54 each have a radius around the central axis 42 approximately equal to the radius of the concave portion 46. In other embodiments, the radius used for the concave arcs 56 and 54 may be larger than the radius of the concave portion 46. In preferred embodiments, the third concave arc 56 and fourth concave arc 54 each have a flared lip on a first end of the bushing 30. Even more preferably, the third concave arc 56 and fourth concave arc 54 each have a flared lip on both ends of the bushing 30.

FIG. 6 illustrates another embodiment of a bushing 100 made from a single piece of metal. The embodiment of FIG. 6 has an “S” shaped cross-section with an additional piece that extends off the tail 102 of the “S”. As may be seen in FIG. 6, the bushing 100 includes a first concave arc 106 and a second concave arc 108. The two arcs 106 and 108 curve around a central axis 110. The two arcs 106 and 108 form a majority of the circumference of the bushing 100. The first concave arc 106 forms the top portion of the “S” in the cross-section and the second concave arc 108 forms the bottom portion of the “S” in the cross-section.

The two concave arcs 106 and 108 are connected by the first central portion 112. The first central portion 112 and the second central portion 104 together form the rounded passage for holding the sensor, tubing, wires etc. While the first central portion 104 forms the center of the “S” in the cross-section, the second central portion 104 is an extension to the end of the “S” in the cross-section. Thus, the second central portion 104 is the portion of the cross-section that is not part of the “S” shape.

As may be seen in FIG. 6, the first central portion 112 and the second central portion 104 are parallel or approximately parallel to each other. Each of the first central portion 112 and the second central portion 104 have a concave arc 114 and 116 respectively. The concave arcs 114 and 116 curve around the central axis 110. The two concave arcs 114 and 116 define the rounded central channel used to hold the sensors, wires, cables etc.

As may be seen in FIG. 6, tabs 120 may be added to the outside edge in a similar fashion to the tabs described in FIG. 3. In addition, the concave arcs 114 and 116 may have flared edges to provide strain relief as described with respect to FIG. 3.

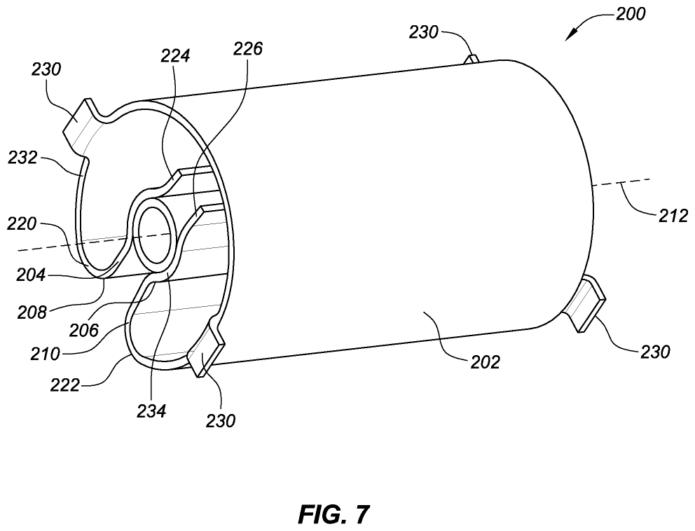

FIG. 7 illustrates another embodiment of a bushing 200. The embodiment in FIG. 7 is comprised of one large arc 202 that wraps almost completely around the central axis 212. As may be seen in FIG. 7, the arc 202 sweeps through more than 320 degrees. In preferred embodiments, the arc 202 sweeps through 320 degrees or more. In yet other embodiments, the arc 202 sweeps through 340 degrees or more. The arc forms the exterior of the cylindrically shaped body 202 of the bushing 200.

Where the arc stops curving around the circumference of the body 202, the arc transitions into rounded corners 220 and 222 at each of its ends. The first rounded corner 220 transitions the arc 202 into the first central portion 224 and the second rounded corner 222 transitions the arc 202 into the second central portion 226. In the embodiment shown in FIG. 7, the first central portion 224 and the second central portion 226 are parallel and run from an exterior edge of the bushing 200 laterally across the bushing to the opposite side. In a preferred embodiment, the first rounded corner 220 and the second rounded corner 222 are mirror images of each other.

In the embodiment shown in FIG. 7, the first central portion 224 and second central portion 226 both terminate before reaching the arc 202. However, in some embodiments, the central portions 224 and 226 may terminate into the arc 202.

Similar to the embodiment shown in FIG. 6, each of the central portions 224 and 226 have a concave arc 232 and 234 respectively. These opposing arcs form the central passage which holds the sensor, wire, cable etc.

As may be seen in FIG. 7, tabs 230 may be added to the outside edge in a similar fashion to the tabs described in FIG. 3. In addition, the concave arcs 232 and 234 may have flared edges to provide strain relief as described with respect to FIG. 3.

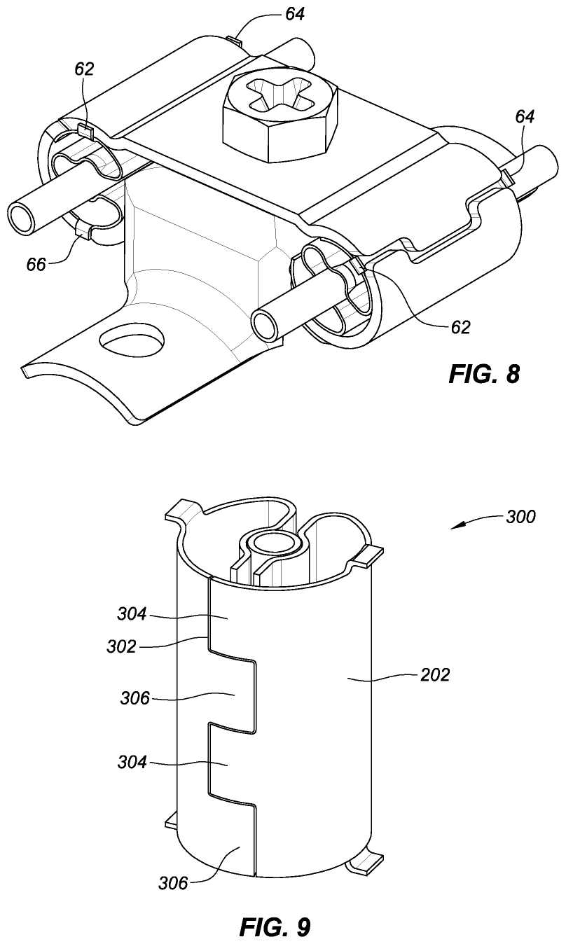

FIG. 8 illustrates a dual clamp with an embodiment of a bushing similar to the one from FIG. 3 assembled into both slots of the clamp. As may be seen in FIG. 8, the length of the bushings is designed to be approximately the same length as the clamps so that just the tabs 62, 64 and 66 stick out. In this configuration, the tabs 62, 64, and 66 (68 not shown) prevent the bushing from sliding laterally within the clamp.

FIG. 9 illustrates an embodiment 300 of a bushing similar to the embodiment of FIG. 7, but built with a two-piece construction. As may be seen in FIG. 9, a seam 302 extends down the longitudinal length of arc 202. The seam 302 defines the two pieces of the bushing 300. As may be appreciated from FIG. 9, the seam is tooth shaped and each piece of bushing 300 has a tooth shaped interface. The left side has teeth 306 that fit into the grooves of the right side and the right side has teeth 304 that fit into grooves on the left side. In other embodiments, other interfaces may be used to join the two pieces and it is not required to use a tooth shaped interface in two-piece constructions.

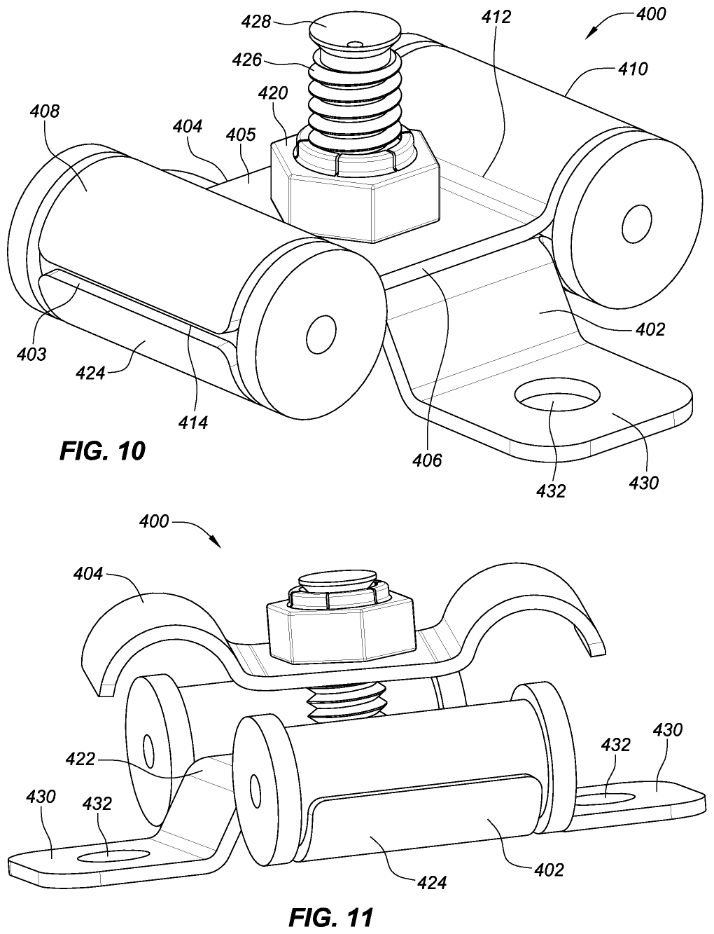

FIG. 10 illustrates an isometric view of a high temperature clamp 400 designed to hold two bushings. As may be seen in FIG. 10, the clamp 400 comprises a base 402 and a top 404. The base 402 and the top 404 mate along a common flat interface plane 406.

The clamp 400 is designed with no loose parts. As use herein “loose parts” means no parts that may become detached from the assembly. All the parts in the assembly of the clamp 400 are designed to be permanently retained by the assembly. Although parts can be “loosened” to create additional clearance between parts, no parts can be separate or detached from the assembly.

The clamp 400 is designed to be a low-cost option where clamps with loose parts are not desired. In preferred embodiments, the base 402 and the top 404, which may also be called the cover 404, are made from formed sheet metal. In other embodiments, they may be machined from a block, pressed, made using additive manufacturing, or made using any of a number of well-known fabrication methods.

In preferred embodiments, the clamps 400 are made from aluminum or steel. This is primarily because the clamps 400 are particularly designed for use in harsh environments like on an aircraft. However, in other embodiments, the clamps 400 made be made from other materials such as plastic, resin or the like, or other low temperature materials without departing from the scope of the teachings herein.

As may be seen in FIG. 10, the clamp 400 is designed to be a dual clamp, i.e. designed to hold two bushings. However, in other embodiments, such as those shown in FIGS. 13-15, the clamp 400 may be designed to hold a single bushing. In other embodiments, clamps may be designed to hold 3 or 4 or more bushings. Accordingly, in the embodiment shown in FIG. 10, the top 404 has a first upper arm 408 and a second upper arm 410. The first upper arm 408 and the second upper arm 410 are cantilevered off the body 405 of the top 404. The embodiment in FIG. 10 has two upper arms 408 and 410, but as will be seen in FIGS. 13-15, embodiments can have only a single upper arm. In yet other embodiments that support securing more than two bushings, more than two upper arms can be used.

Returning to FIG. 10, each upper arm 408 and 410 is designed to replicate and mate with the outside of a bushing. In the embodiment shown in FIG. 10, the first upper arm 408 and the second upper arm 410 extend outwardly and away from the body 405 of the top 404. In the embodiment shown in FIG. 10, each arm 408, 410 is an arc or a portion of a circle wherein the inside radius of the arc is designed to mate with the outside diameter of a bushing. To this end, the arc may be designed to have its center of curvature be the longitudinal axis of the bushing.

In the embodiment of FIG. 10, each arm 408 and 410 is comprised completely of an arc with no real additional features. While other features may exist on the arms, making them entirely of an arc may reduce manufacturing costs and create a simplistic mating interface.

As may be seen in FIG. 10, the body 405 of the top transitions into a first end 412 of the arc and the arc proceeds up away from the surface of the body 405 and back down around the radius of curvature of the arc. The arc then terminates in the second end 414. The arc is swept through 180 degrees or less such that the second end terminated approximately in line with the plane formed by the top 404 or slightly above the plane formed by the top 404. Typically, the arc is swept through slightly less than 180 degrees to leave a small gap 403 between the top 404 and bottom 402 when the two pieces are assembled around a bushing. In preferred embodiments, the arcs on the arms are swept through between 150 and 180 degrees.

Although in preferred embodiments, the arcs of the arms are swept through similar angles such that the upper arm and lower arm are the same and basic mirror images, in other embodiments, the arcs may be swept through different angles such that the top or bottom is smaller and its corresponding side bigger. For example, the embodiment shown in FIG. 8 has a top arm swept through a smaller angle while the bottom arm has an arc swept through a larger angle.

Although as may be seen in FIG. 10, the upper arms 408 and 410 use arcs, they may be any other shape in order to mate with the exterior surface of a bushing. For example, if the exterior shape of the bushing was hexagonal, the interior surface of the upper arms 408 and 410 could also be made hexagonal to match. This is just one example and one skilled in the art will appreciate that the actual shape of the interior surface of the bushing arms 408 and 410 may be varied to any shape to match the exterior surface shape of the bushing.

Although not shown in FIG. 10, because its hidden below the nut 420, the top 404 has a through hole through the body 405 that allows the top 404 to slide over top of the stud 426, which is coupled to the base 402. The through hole in the body can be located through any portion of the body 405 of the top 404. In preferred embodiments, the through hole is centered in the body 405 of the top 404 to create equal pressure in arms 408 and 410 when the top 404 and bottom 402 are assembled in operation.

The assembly of the clamp 400 further comprises a base 402. The base 402 is a separate part from the top 404. Similar to the top 404, the base 402 comprises a bottom body 422 (not shown in FIG. 10 because its hidden by the top) and at least one lower arm 424 cantilevered away from the bottom body;

The arms of the bottom body 422 and arms 424 of the base 402 are designed to generally be the mirror image of the top 404. Similar to a clam shell configuration where the two halves of an assembly mate together, the top 404 and base 402 of the clamp 400 are designed to mate together to hold a bushing or other object and thus, are mirror images of each other in the body 422 and arm(s) 424.

The base 402 further comprises a stud 426 affixed to the bottom body 422 of the base 402 at a first end and extending therefrom to a distal end, the distal end 428. The stud 426 is designed to permanently capture a fastener. The fastener shown in FIG. 10 is a nut 420 but the fastener could be any fastener than maybe permanently captured by the stud 426 and can secure the top 404 to the base 402. In preferred embodiments, the distal end 428 of the stud 426 is deformed to permanently capture a fastener. By permanently capture the fastener, it is meant that the fastener cannot come loose from the assembly under any normal circumstances.

As may be appreciated a fastener 420 is coupled to the stud such that the fastener 420 (in this embodiment a nut) can selectively translate along the longitudinal axis of the stud 426. In embodiments that use a nut as the fastener 420, the stud 426 may be threaded to accommodate the nut 420.

In preferred embodiments, the stud 426 is permanently pressed into the base 402. This may be done by press fit, interference fit or any other type of pressing. In other embodiments, the stud 426 may be permanently attached to the base using other methods such as welding or the like. In yet other embodiments, the stud may be removably attached to the base as long as its secure such that it won't come loose during normal conditions.

As is known in the art, the nut 420 may include a nylon portion or other device to prevent the nut from loosening once tightened.

During assembly, the 404 and a fastener 420 will be installed on to the stud 426 and the distal end 428 of the stud 426 will be deformed to keep the fastener 420 and the top 404 captive.

In preferred embodiments, the clamp includes a first mating interface 430 cantilevered away from the top 404 or the base 402. In the embodiment shown in FIG. 10, the mating interface 430 is just a flange cantilevered down and away from the bottom body 422 of the base 402. However, the mating interface may be any type of interface and may extend from either the top 404 or the base 402. In addition, the mating interface 430 can extend from either the body of the top 404 or base 402 or from one of the arms 408, 410 or 424. While it is possible to extend the mating interface 430 from an arm, it is not the ideal embodiment due to vibrational concerns.

In the embodiment of FIG. 10, the mating interface 430 is just a flange with a through hole 432. However, the mating interface 430 may be any type of interface and may have threads, through holes, flanges, tie straps or any other type of mating feature. In preferred embodiments, the mating interface 430 extends down away from the base 402 past the bottom surface of the lower arm 424 and also extends out away from the bottom body 422. As may be appreciated, other mating interface designs may be used.

In the embodiment shown in FIG. 10, the body 405 of the top 404 and the bottom body 422 of the base 402 are both flat and mate together in a plane. However, in other embodiments, the body 405 and the bottom body 422 may be curved or formed to fit or interface with a particular mounting surface on the upper level assembly.

When the parts of the clamp 400 are assembled together, the top 404 is coupled to the base 402 by placing the through hole down over the stud 426 and permanently capturing the fastener 420 between the first end and the distal end 428 of the stud 426. This is typically done by deforming the distal end 428 of the stud 426. In the case of a threaded fastener like a nut, the distal end 428 can just be flattened such that the threaded fastener cannot come loose or be separated from the stud 426.

When assembling the top 404 to the base 402, the top 404 and the base 402 should be oriented such that the upper arms align with the lower arms. By align, it is meant that the upper arms and the lower arms are oriented to form a clam shell to receive an object such as a bushing.

In the embodiment shown in FIG. 10, the top 404 includes two upper arms 408 and 410 on opposite sides of the body 405 and the base 402 has two corresponding lower arms on opposite sides of the bottom body 422. However, in other embodiments the upper arms 408 and 410 and corresponding lower arms may be on adjacent sides. In embodiments designed to hold three bushings, there may be an upper arm on three adjacent sides. Although other embodiments are possible, the preferred embodiment has either a single upper and lower arm or two upper and lower arms on opposite sides of the body.

FIG. 11 illustrates the clamp 400 of FIG. 10 with the top 404 in a loosened position and rotated approximately 90 degrees from its clamped position. As may be seen in FIG. 11, the clamp 400 may have more than one mating interfaces 430. In the embodiment shown in FIG. 11, the clamp 400 has two mating interfaces 430. In other embodiments, even more mating interfaces 430 may be included and located in many different places. In the embodiment shown in FIG. 11, the mating interfaces are on opposite sides of the bottom body 422 and are on the adjacent sides to the lower arms 424. In yet other embodiments, other location and orientation may be used.

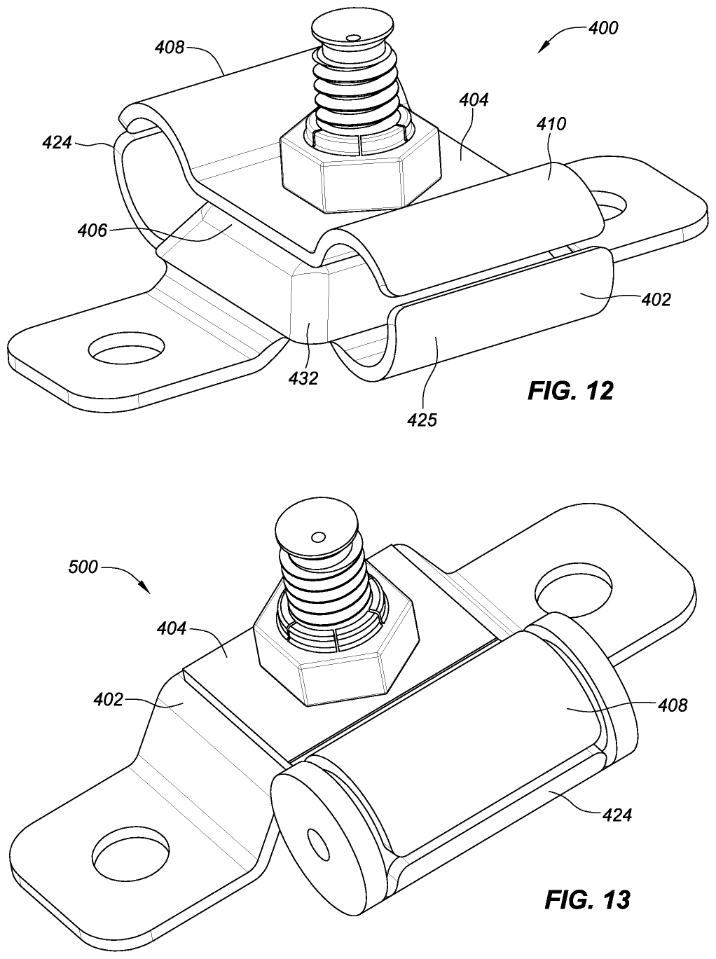

FIG. 12 illustrates the clamp 400 of FIGS. 10 and 11 without the bushings present. As may be seen in FIG. 12, the base 402 of the clamp 400 may have the sides connected with rounds 432 such that the base 402 forms a box shaped structure. Attaching the sides of the base 402 with rounds, or forming it with rounds 432, adds strength to the structure of the base 402.

As may also be seen in FIG. 12, the upper arms 408 and 410 and lower arms 424 and 425 are designed to extend away from the body of the clamp 400 in a cantilevered fashion. Even when completely assembled, a gap 403 may exist between the upper and lower arms. This allows the upper arms 408 and 410 and lower arms 424 and 425 to act like springs to clamp a bushing or other device between them.

FIG. 13 illustrates an isometric view of a clamp 500 similar to those of the previous figures but designed to hold a single bushing. As may be appreciated, clamp 500 is similar in every way to clamp 400 of FIGS. 10-12 but the top 404 and base 402 only have a single upper arm 408 and lower arm 424.

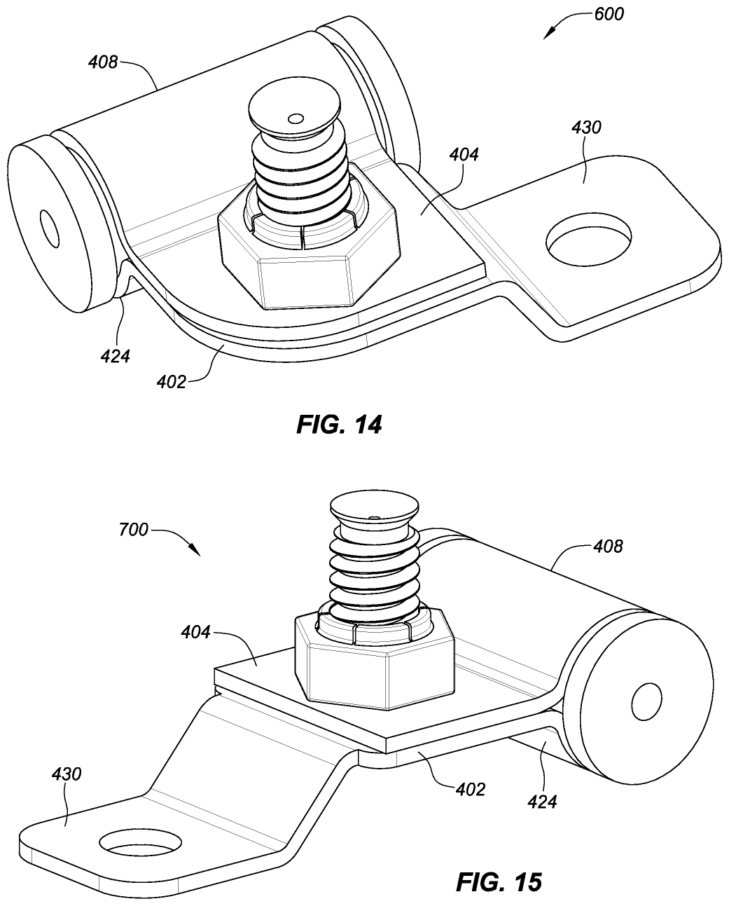

FIG. 14 illustrates an isometric view of a clamp 600 similar to the clamp 500 in FIG. 13 but designed with only a single mating interface 430 on a side of the clamp 600 adjacent to the upper arm 408 and lower arm 424. The clamp 600 may be used as a corner clamp where the wires need to be held at a 90 degree angle to the mounting surface.

FIG. 15 illustrates an isometric view of a clamp 700 similar to the clamp 600 in FIG. 14 but designed with only a single mating interface 430 on a side of the clamp 700 opposite to the upper arm 408 and lower arm 424. As may be appreciated by the different embodiments shown in FIGS. 10, 13, 14 and 15, the number of arms and mounting interfaces may be varied from embodiment to embodiment to suit the needs of the application. In addition, the special orientation of the arms and mounting interfaces may be varied between themselves and with respect to one another to suit the needs of the application.

In the examples herein, the clamp 400 was described in relation to holding one or more bushings. However, the bushings are not contemplated as being part of the clamp invention by itself and one will appreciate that the clamp could be used to hold anything, such as a bare cable, not just a bushing. To this end, although reference to holding a bushing was used in describing the clamp, the clamps are in no way limited to holding a bushing either in design or application.

In yet another embodiment, the mating portion may be located on a separate part from the top 404 and the base 402. The separate part comprising the mating interface has a through hole and slides over the stud and is sandwiched between the top and the base during assembly. This allows the mating interface part to rotate around the stud and base such that the mating interface flange can be located at any angle with respect to the arms on the top and base. In preferred embodiments, the separate part may have features such as notches or grooves or tabs to prevent it from rotating once the assembly is tightened down.

The embodiments described herein are exemplary and are not meant to limit the scope of the claims as claimed below. As one skilled in the art will appreciate, many modifications and substitutions to the embodiments disclosed herein are possible without departing from the spirit of the embodiments disclosed.

What is claimed is:

1. A clamp comprising:
a top comprising a body and at least one upper arm that is cantilevered away from the body;
a through hole that passes through the body of the top;
a base separate from the top and comprising a bottom body and at least one lower arm cantilevered away from the bottom body;
a stud affixed to the bottom body of the base at a first end and extending therefrom to a distal end, the distal end of the stud being designed to permanently capture a fastener;
a fastener coupled to the stud such that the fastener can selectively translate along the longitudinal axis of the stud; and
a first mating interface extending away from the top or the base;
wherein the top is coupled to the base by placing the through hole down over the stud and permanently capturing the fastener between the first end and the distal end of the stud such that the at least one upper arm and at least one lower arm are aligned.

2. The clamp of claim 1, wherein the stud is threaded and the distal end is deformed to capture the fastener.

3. The clamp of claim 2, wherein the fastener is a nut.

4. The clamp of claim 1, wherein the at least one upper arm is a first arc.

5. The clamp of claim 4, wherein the first arc has a first end coupled to the body and wherein the arc is swept through between 150 and 180 degrees.

6. The clamp of claim 5, wherein the at least one lower arm is a second arc.

7. The clamp of claim 6, wherein the second arc has a first end coupled to the base and wherein the second arc is swept through between 150 and 180 degrees.

8. The clamp of claim 1, wherein the first mating interface is cantilevered away from the base.

9. The clamp of claim 1, wherein when the top is assembled to the base and the fastener is fully tightened, a gap remains between a first distal end of the at least one upper arm and the at least one lower arm.

10. The clamp of claim 1, wherein the clamp has two upper arms on opposite sides of the top and two lower arms on opposite sides of the base.

11. The clamp of claim 10, wherein the two upper arms are arcs and the two lower arms are arcs and the axes of rotation of the two upper arms are in a same first plane and wherein the axes of rotation of the two lower arms are in a same second plane.

12. The clamp of claim 11, wherein the first plane and the second plane are the same plane.

13. The clamp of claim 1, wherein the top and base are made from formed sheet metal.

14. A clamp comprising:
a top comprising a body and at least one upper arm that is cantilevered away from the body;
a through hole that passes through the body of the top;
a base separate from the top and comprising a bottom body and at least one lower arm cantilevered away from the bottom body;
a threaded stud affixed to the bottom body of the base at a first end and extending therefrom to a distal end, the distal end of the threaded stud being deformed to permanently capture a nut;
a nut coupled to the threaded stud such that the nut can selectively translate along the longitudinal axis of the threaded stud; and
a first mating interface extending away from the top or the base;
wherein the top is coupled to the base by placing the through hole down over the threaded stud and permanently capturing the nut between the first end and the distal end of the threaded stud such that the at least one upper arm and at least one lower arm are aligned.

15. The clamp of claim 14, wherein the at least one upper arm and the at least one lower arm are both in the shape of an arc.

16. The clamp of claim 15, wherein at least one upper arm and the at least one lower arm are swept through between 150 and 180 degrees to form the arc.

17. The clamp of claim 14, wherein the clamp has two upper arms on opposite sides of the top and two lower arms on opposite sides of the base.

18. A clamp comprising:
a top comprising a body and at least one upper arm that is a first arc cantilevered away from the body;
a through hole that passes through the body of the top;
a base separate from the top and comprising a bottom body and at least one lower arm that is a second arc cantilevered away from the bottom body;
a threaded stud affixed to the bottom body of the base at a first end and extending therefrom to a distal end, the distal end of the threaded stud being deformed to permanently capture a nut;
a nut coupled to the threaded stud such that the nut can selectively translate along the longitudinal axis of the threaded stud; and
a first mating interface in the form of a flange extending away from the top or the base;
wherein the top is coupled to the base by placing the through hole down over the threaded stud and permanently capturing the nut between the first end and the distal end of the threaded stud and wherein the top and base are assembled such that the first arc and the second arc have an axis of rotation that is the same.

19. The clamp of claim 18, wherein the clamp has two upper arms on opposite sides of the top and two lower arms on opposite sides of the base.

20. The clamp of claim 18, wherein the first arc and the second arc are swept through between 150 and 180 degrees.
